(19) United States
(12) Patent Application Publication
(10) Pub. No.: US 2016/0033635 A1
(43) Pub. Date: Feb. 4, 2016

(54) NON-STATIONARY MULTI-PATH RFID TAG LOCATION IDENTIFICATION SYSTEM AND METHOD

(71) Applicant: INNOVATIVE TIMING SYSTEMS, LLC, St. Louis, MO (US)

(72) Inventor: Kurt S. Hansen, Chesterfield, MO (US)

(73) Assignee: INNOVATIVE TIMING SYSTEMS, LLC, St. Louis, MO (US)

(21) Appl. No.: 14/775,478

(22) PCT Filed: Mar. 18, 2014
(86) PCT No.: PCT/US14/31125

§ 371 Date: Sep. 11, 2015

Related U.S. Application Data
(60) Provisional application No. 61/798,350, filed on Mar. 15, 2013.

(51) Int. Cl. G01S 13/75

(52) U.S. Cl. CPC G01S 13/75

(57) ABSTRACT

A system and method provides for identifying a location of an RFID tag in a coordinate system, a tag reader receives a first tag read from a first antenna and a second tag read from a second antenna, the tag reader determines a first tag read time and a first tag read parameter based on the first tag read and a second tag read time and a second tag read parameter based on the second tag read, and transmits data including the tag identifier, the first tag read time, the first tag read parameter, the second tag read time and the second tag read parameter and a RFID tag location system receives the transmitted data and compares the first tag read parameter with the second tag read parameter, and determines a tag position of the RFID tag within the coordinate system of the monitored area therefrom.

### CROSS-REFERENCE TO RELATED APPLICATIONS

This application claims the benefit of U.S. Provisional Application No. 61/798,350, filed on Mar. 15, 2013, the disclosure of which is incorporated herein by reference.

### FIELD

The present disclosure relates to systems for determining the location of radio frequency identification (RFID) tags, and more specifically, to identification of a location of a particular RFID tag location within a radio frequency (RF) detection area and the resulting features and method resulting therefrom in an event timing system.

### BACKGROUND

The statements in this section merely provide background information related to the present disclosure and may not constitute prior art.

One of the challenges in utilizing RFID tags for timing sporting events is the ability to read tags with a high degree of reliability. This is more often the case when passive RFID tags are being used. Problems can include null spots within the antenna radio frequency (“RF”) field, poor signal strength due to a damaged tag, environmental challenges due to mud or water, blockage of the tag due to other participants in the same RF field, and overload due to too many tags being within the RF field at the same time. In addition, most RFID timing systems used for sporting events have historically had single points of failure due to their antenna design, which utilize mats, plastic ramps or wire loop antennas, which have limited RF fields. As a result of these challenges, most timing systems that utilize these types of antennas will employ some method of redundancy to try and eliminate the single points of failure, resulting in increased cost and complexity. This approach to redundancy also creates an additional problem; the exact determination of the tag read may not conform to the specific location desired. These problems are well understood have existed in the sports timing industry for many years.

### SUMMARY

The inventor hereof has succeeded at designing improvements to an RFID tag reader based timing system that utilizes a plurality of antenna for identifying a location of the RFID tag within a coordinate system and utilizing the determined location for determining the time of passing of the participant past a monitored line that is within the same coordinate system. In this manner, a more accurate determination of the actual point of passing of the participant past the monitored line is determined.

In one aspect, a system and method provides for identifying a location of an RFID tag in a coordinate system, a tag reader receives a first tag read from a first antenna and a second tag read from a second antenna, the tag reader determines a first tag read time and a first tag read parameter based on the first tag read and a second tag read time and a second tag read parameter based on the second tag read, and transmits data including the tag identifier, the first tag read time, the first tag read parameter, the second tag read time and the second tag read parameter and a RFID tag location system receives the transmitted data and compares the first tag read parameter with the second tag read parameter, and determines a tag position of the RFID tag within the coordinate system of the monitored area therefrom.

According to another aspect, a system is provided for identifying a geographic location of an RFID tag with a unique tag identifier within a monitored area having a predefined X, Y, Z coordinate system. The system includes a tag reader and a RFID tag location system. The tag reader has a computer, a memory, an output interface and an input interface. The input interface is communicatively coupled to a first RFID antenna having a first antenna identifier and a second RFID antenna having a second antenna identifier with each positioned proximate to the monitored area and being spaced apart from each other. The tag reader receives a first RFID tag read with the tag identifier from the first RFID antenna and a second RFID tag read with the tag identifier from the second of the RFID antenna. The tag reader determines a first tag read time and a first tag read parameter associated with the received first tag read and a second tag read time and a second tag read parameter associated with the received second tag read. The tag reader transmits a first tag read message including the tag identifier, the first tag read time, the determined first tag read parameter, and the first antenna identifier over the output interface and transmits a second tag read message including the tag identifier, the second tag read time, the determined second tag read parameter and the second antenna identifier over the output interface. The RFID tag location system receives the first tag read message and the second tag read message, compares the determined first tag read parameter with the determined second tag read parameter, and determines a tag position of the RFID tag within the coordinate system of the monitored area as a function of the comparing.

According to yet another aspect, a system is provided for determining a time of passing of a participant in a timed event having an RFID tag with a unique tag identifier with the timed event having a monitored area having a predefined X, Y, Z coordinate system and the monitored area of the timed event having a monitored line defined within the monitored area coordinate system. A tag reader is communicatively coupled to a first RFID antenna having a first antenna identifier and a second RFID antenna having a second antenna identifier with each positioned proximate to the monitored area and spaced apart from each other. The tag reader receives a first RFID tag read with the tag identifier from the first RFID antenna and a second RFID tag read with the tag identifier from the second of the RFID antenna. The tag reader determines a first tag read time and a first tag read parameter associated with the received first tag read and determines a second tag read time and a second tag read parameter associated with the received second tag read. The reader transmits a first tag read message including the tag identifier and the first tag read time, the determined first tag read parameter, and the first antenna identifier over an output interface and transmits a second tag read message including the second tag read time, the determined second tag read parameter and the second antenna identifier over the output interface. An event timing system receives the first tag read message and the second tag read message from the tag reader and compares the determined first tag read parameter with the determined second tag read parameter as received in the first and second tag read messages. The timing system then determines a tag position of the RFID tag within the coordinate system of the monitored area as a function of the comparing. The timing system determines a relative Y distance position of the RFID tag from a comparison of the Y coordinate of the determined tag position within the coordinate system and a Y coordinate of the defined monitored line. The timing system then determines the time of passing of the RFID tag past the monitored line when the determined relative Y distance position is about zero and as a function of the tag read time in the tag read message associated therewith.

According to yet another aspect, a method is provided for determining a time of passing of a participant in a timed event having an RFID tag with a unique tag identifier with the timed event having a monitored area having a predefined X, Y, Z coordinate system and the monitored area of the timed event having a monitored line defined within the monitored area coordinate system. The method includes processes performed in a tag reader having a computer, a memory, an output interface and an input interface with the input interface being communicatively coupled to a first FRID antenna having a first antenna identifier and a second RFID antenna having a second antenna identifier with each positioned proximate to the monitored area and spaced apart from each other. These processes include receiving a first RFID tag read with the tag identifier from the first RFID antenna and receiving a second RFID tag read with the tag identifier from the second of the RFID antenna. It also includes determining a first tag read time and a first tag read parameter associated with the received first tag read and determining a second tag read time and a second tag read parameter associated with the received second tag read. The process includes transmitting a first tag read message including the tag identifier and the first tag read time, the determined first tag read parameter, and the first antenna identifier and a second tag read message including the second tag read time, the determined second tag read parameter and the second antenna identifier over the output interface. The method further includes processes performed in an event timing system. These processes include receiving the first tag read message and receiving the second tag read message. This also includes comparing the determined first tag read parameter with the determined second tag read parameter as received in the first and second tag read messages and determining a tag position of the RFID tag within the coordinate system of the monitored area as a function of the comparing. The process further includes determining a relative Y distance position of the RFID tag from a comparison of the Y coordinate of the determined tag position within the coordinate system and a Y coordinate of the defined monitored line. This further includes determining a time of passing of the RFID tag past the monitored line when the determined relative Y distance position is about zero and as a function of the tag read time in the tag read message associated therewith.

According to still another aspect, a method is provided for identifying a geographic location of an RFID tag with a unique tag identifier within a monitored area having a predefined X, Y, Z coordinate system. The method includes processes performed in a tag reader having a computer, a memory, an output interface and an input interface that is communicatively coupled to a first

RFID antenna having a first antenna identifier and a second RFID antenna having a second antenna identifier with each positioned proximate to the monitored area and spaced apart from each other. The tag reader processes include receiving a first RFID tag read with the tag identifier from the first RFID antenna, receiving a second RFID tag read with the tag identifier from the second of the RFID antenna, determining a first tag read time and a first tag read parameter associated with the received first tag read, determining a second tag read time and a second tag read parameter associated with the received second tag read, and transmitting a first tag read message including the tag identifier, the first tag read time, the determined first tag read parameter, and the first antenna identifier and a second tag read message including the tag identifier, second tag read time, the determined second tag read parameter and the second antenna identifier over the output interface. The method also includes processes performed in a RFID tag location system. Those processes include receiving the first tag read message and receiving the second tag read message. The process also includes comparing the received first tag read parameter with the received second tag read parameter and determining a tag position of the RFID tag within the coordinate system of the monitored area as a function of the comparing.

According to some aspects, a system and/or method for determining a time of a passing of a participant passed a monitored line on a route based on a determined location from a plurality of RFID tag reader antenna having a tag reader system receiving a plurality of tag reads from a plurality of RFID antenna of the same RFID tag and tag read data associated with each of the tag reads, providing the tag reads and the tag read data to a timing system, the tag read including an identification of the RFID tag and a time of the reading of the RFID tag by the reading antenna, the tag read data including information about the tag read by the antenna that is in addition to and different from the information of the tag read, the timing system receiving the tag reads and the tag read data from each of the plurality of antenna for the same RFID tag and determining at least one of the X, Y and Z positions (the location) of the RFID tag within a coordinate system based on the plurality of tag read data for the tag, and determining the time of passing of the participant past the monitored line responsive to the determined at least one position.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is an illustration of a system and method for determining a time of a passing of a participant passed a detection line along a traveled route using RFID tags, antennas and a RFID tag reader systems as known in the art.

FIG. 2 is an RFID timing system having two RFID tag reading systems each multiple antennas for reading the RFID tags that can be used to define a location of a participant relative to a virtual finish line within the monitored area defined between the two RFID antenna systems according to one embodiment.

FIG. 3 is a close up illustration of a timing system illustrating an RFID tag being read by three RFID tag reader antenna for capturing multiple tag reads from the RFID tag read and determining one or more tag read parameters associated with the tag reads of each antenna and the providing the tag reads and the tag read parameters to a tag location system for determination of location of the RFID tag within a coordination system.

FIG. 4 is a schematic drawing of a route having an RFID tag traveling thereon, the route having a coordinate system that is positioned immediately in front of a monitored point having four RFID antenna coupled to one or more tag readers for determining the multiple positions of the RFID tag according to one embodiment.

FIG. 5 is a schematic drawing showing a location detection location having four antennas with overlapping antenna patterns (RF fields) and having null spot elimination over the monitored area according to one embodiment.

FIG. 6 is a schematic drawing illustrating tag reading of an RFID tag moving within the monitored area and the determination of two positions of the RFID tag at two advanced spaced apart locations prior to or approaching the location detection system and for determining the Y position of the FRID tag relative to a monitored lines in such coordinate system according to one embodiment.

FIG. 7 is a schematic drawing illustrating an RFID tag positioned in a coordinate system that includes two different sets of detection systems having spaced apart RFID antennas coupled to two tag readers and one timing system for determining the tag position within a coordinate system according to one embodiment.

FIG. 8 is a schematic drawing of a monitored area having a wide width and having a plurality of RFID tags traveling a route path through the monitored area for which a location is determined for each according to one exemplary embodiment.

FIG. 9 is a listing of communication messages and formats including messages for reading RFID tag data, obtaining tag reads and for controlling the reading of the RFID tags, and transmitting tag read parameters as determined by a tag reader according to some embodiments of the disclosed system and method.

FIG. 10 is a timing diagram of a process for tag reading of timing data by a tag reader and transmission of the tag read with the determined tag read data to the timing system according to one embodiment.

FIG. 11 is a flow diagram of a process for determining a location of a RFID tag using multiple tags reads according to some embodiments.

FIG. 12 is a flow diagram for processing a plurality of RFID tag reads from a plurality of RFID antennas and determining one or more location of the RFID tag in a coordinate system and determination of the time of passing by a monitored point within the monitored area according to one embodiment.

FIG. 13 is a flow chart showing a process by two RFID tag readers each having a plurality of antenna making RFID tag reads of the same RFID tag and tag read parameter data for use in determining the location of the RFID tag in a coordinate system.

FIG. 14 is a flow chart of a process for determining the location and time of passing of an RFID tag based on multiple tag read systems or multiple antenna of various embodiments as described herein.

FIG. 15 illustrates an exemplary computer system environment according to one embodiment.

FIG. 16 illustrates an exemplary client-server environment according to yet another embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses. Before turning to the figures and the various exemplary embodiments illustrated therein, a detailed overview of various embodiments and aspects is provided for purposes of breadth of scope, context, clarity, and completeness.

In some embodiments as will be described herein, a system and method provides for identifying a location of an RFID tag in a coordinate system, a tag reader receives a first tag read from a first antenna and a second tag read from a second antenna, the tag reader determines a first tag read time and a first tag read parameter based on the first tag read and a second tag read time and a second tag read parameter based on the second tag read, and transmits data including the tag identifier, the first tag read time, the first tag read parameter, the second tag read time and the second tag read parameter and a RFID tag location system receives the transmitted data and compares the first tag read parameter with the second tag read parameter, and determines a tag position of the RFID tag within the coordinate system of the monitored area therefrom.

In some embodiment embodiments, a system and/or method for determining a time of a passing of a participant passed a monitored line on a route based on a determined location from a plurality of RFID tag reader antenna having a tag reader system receiving a plurality of tag reads from a plurality of RFID antenna of the same RFID tag and tag read data associated with each of the tag reads, providing the tag reads and the tag read data to a timing system, the tag read including an identification of the RFID tag and a time of the reading of the RFID tag by the reading antenna, the tag read data including information about the tag read by the antenna that is in addition to and different from the information of the tag read, the timing system receiving the tag reads and the tag read data from each of the plurality of antenna for the same RFID tag and determining at least one of the X, Y and Z positions (the location) of the RFID tag within a coordinate system based on the plurality of tag read data for the tag, and determining the time of passing of the participant past the monitored line responsive to the determined at least one position.

In some embodiments a system is provided for identifying a geographic location of an RFID tag with a unique tag identifier within a monitored area having a predefined X, Y, Z coordinate system. The system includes a tag reader and a RFID tag location system. The tag reader has a computer, a memory, an output interface and an input interface. The input interface is communicatively coupled to a first RFID antenna having a first antenna identifier and a second RFID antenna having a second antenna identifier with each positioned proximate to the monitored area and being spaced apart from each other. The tag reader receives a first RFID tag read with the tag identifier from the first RFID antenna and a second RFID tag read with the tag identifier from the second of the RFID antenna. The tag reader determines a first tag read time and a first tag read parameter associated with the received first tag read and a second tag read time and a second tag read parameter associated with the received second tag read. The tag reader transmits a first tag read message including the tag identifier, the first tag read time, the determined first tag read parameter, and the first antenna identifier over the output interface and transmits a second tag read message including the tag identifier, the second tag read time, the determined second tag read parameter and the second antenna identifier over the output interface.

The RFID tag location system receives the first tag read message and the second tag read message, compares the determined first tag read parameter with the determined second tag read parameter, and determines a tag position of the RFID tag within the coordinate system of the monitored area as a function of the comparing. In some embodiments, the RFID tag location system compares the first tag read time with the second tag read time as received in the first and second tag read messages, and the determines the tag position within the coordinate system of the monitored area also a function of the comparing of the first and second tag read times. The determined RFID tag position can be a coordinate position defined by an x, y, z value.

In some embodiments, the monitored area includes a monitored line, and wherein the RFID tag location system determining a time of passing of the RFID tag past the monitored line responsive to the determined tag position and at least one of the first tag read time and the second tag read time.

In some embodiments, the determined first tag read parameter is a first RF signal strength of the first tag read and the determined second tag read parameter is a second RF signal strength of the received second tag read.

The RFID tag location system can include a location determination module including computer executable instructions for triangulation for performing the comparing and determining The location determination can in various embodiments utilize tag read parameters such as, by way of example, a signal strength of the received RF tag read, a relative radio frequency sign strength of the RF tag read, an RF polarization, a RF polarization shift, a phase of the received RF tag read, a phase shift of the received RF tag read, a propagation delay of the RF tag read, a Q value of the RFID tag, a signal strength of a tag read request or wakeup message sent from an antenna and as received by the RFID tag, from either or both of the first tag read and the second tag read.

Of course it should understood to those of skill in the art that while a first and second tag read, or a first and second of any parameter, element of feature of this system can be two or more of such and still be within the scope of the present description.

In some embodiments, the RFID tag location system includes a predefined first antenna position within the monitored coordinate system and a second predefined antenna position within the monitored coordinate system. As the tag location has the locations of the antenna within the coordinate system the tag location system can utilize these in the determining of the tag position within the monitored area coordinate system.

In some embodiments, the RFID tag location system includes a first antenna pattern for the first antenna as defined within the monitored coordinate system and a second antenna pattern defined within the monitored coordinate system. In such embodiments, the first and second antenna patterns can be used or compared or in the determining such as the comparing the first tag read parameter to the first antenna pattern and the second tag read parameter to the second antenna pattern. This can include, but is not limited to a first antenna pattern and the second antenna pattern each defined within the RFID tag location system by three dimensional antenna radiation patterns such as defined by a plurality of antenna radiation energy levels of the relative antenna within the monitored area coordinate system. In this embodiment, the first tag read parameter can be a signal strength of the first tag read and the second tag read parameter can be a signal strength of the second tag read and the location detection system can use these in the determining of the tag position or based on an association of the first tag read parameter with the first antenna pattern and the second tag read parameter includes an association of the second tag read parameter with the second antenna pattern.

In some embodiments where the antenna pattern are known, the RFID tag location system stores each of the first and second tag read messages including the first and second tag read times and determines a duration of the RFID tag within each of the first antenna pattern of the first antenna and the second antenna pattern of the second antenna. The RFID tag location system can determine the tag position at least in part on a comparison of determined tag duration in at least one of the first and second antenna patterns.

In some embodiments, the antenna radiation patterns of the antenna can be calibrated before, during or after placement of the antenna at the detection point. These antenna calibrations or the calibrating data based thereon can be stored in a memory of the RFID tag location system and used in the determining of the position of the tag base on at least one of the stored antenna calibrations. This calibration can include calibrating two or more of the antenna so that their respective antenna patterns overlap. This can be calibrated and configured by positioning of the antenna so that there are no null points within the monitored area. In some embodiments, the first and second antenna are calibrated and positioned so that the first antenna pattern and the second antenna pattern at least partially overlap and that all coordinate points within the coordinate system of the monitored area are within at least one of the first antenna pattern and the second antenna pattern.

In some embodiments, the first and second antenna are calibrated to transmit each read request and to receive the tag read from the RFID tag at a first frequency and a second frequency respectively. Generally, these are different frequencies but they can be the same and also can varying over time.

The tag reader can provide a first tag read request to the first antenna and provide a second tag read request to the second antenna such that the first antenna transmits a first tag read message to the RFID tag responsive to receiving the provided first tag read request and the received first tag read is responsive to the first tag read message. This can include the second antenna transmitting a second tag read message to the RFID tag responsive to receiving the provided second tag read request and the received second tag read can be responsive to the second tag read message. In some embodiments, the tag reader provides a first tag frequency with the first tag read request and a second frequency that is different from the first frequency with the second read request. In such embodiments, the first antenna transmit the first tag read request and receives the tag read at the first frequency and the second antenna transmits the second tag read request and receives the second tag read at the second frequency.

In some embodiments, the tag reader determines a first antenna transmit parameter for the first antenna for transmitting the first tag read message and determines a second antenna transmit parameter for the second antenna for transmitting the second tag read message. In such embodiments, the first antenna transmits the first tag read message at the determined first antenna transmit parameter and the second antenna transmits the second tag read message at the determined second antenna transmit parameter. The tag reader then transmits the determined first antenna transmit parameter with the first tag read message and transmits the determined second antenna transmit parameter with the second tag read message. Once received by the tag location system, the tag location system can determine the tag position within the coordinate system as a function of the received first antenna transmit parameter and the received second antenna transmit parameter. In some embodiments, the first antenna transmit parameter is a first antenna power level and the second transmit parameter is a second antenna power level. In such, the first tag read parameter can be a signal strength of the first tag read and the second tag read parameter can be a signal strength of the second tag read. In some embodiments, the first antenna transmit parameter is a first antenna power level and the second transmit parameter is a second antenna power level and wherein the first tag read parameter is a signal strength of the first tag read and the second tag read parameter is a signal strength of the second tag read. In some cases, the first antenna transmit parameter is a first antenna frequency and the second transmit parameter is a second antenna frequency.

In some embodiments, the tag reader can adjusts a rate of tag reads for the first antenna based on a determined signal strength of the received first tag read. This can include changing or establishing and transmitting to the RFID tag a changed Q (sleep) value.

In some embodiments, the tag reader ignores one or more first tag reads from the first antenna and prioritizes a reading of first tag reads as a function of the received second tag from the second antenna.

In some embodiments, the RFID tag is a first RFID tag within the monitored area, and wherein RFID tag location system differentiates the first RFID tag from a second RFID within the monitored area based on the determined position.

In some embodiments, the monitored area includes a monitored line defined within the monitored area coordinate system and such is stored in a memory of the RFID tag location system. The RFID tag location system can then determine a relative Y distance position of the RFID tag from a comparison of the Y coordinate of the determined tag position within the coordinate system and the Y coordinate of the monitored line. In some such embodiments, the RFID tag location system determines a time of passing of the RFID tag past the monitored line when the determined relative Y distance position is about zero and as a function of the tag read time in the tag read message associated therewith.

In these or other embodiments, the monitored line can include an X distance defining an X width of the monitored line across the monitored area. In such cases, the RFID tag location system determines the X position coordinate of the RFID tag relative to the X width of the monitored line. Similarly, the monitored area typically can have a surface with a Z distance defining the surface within the coordinate system. In such embodiments, the RFID tag location system can determine a height of the RFID tag within the monitored area above the surface.

As described above the monitored area can be a monitored area of a timed event such as a start line, a split point or a finish line. When a monitored event occurs, a plurality of participants each having a unique RFID tag and there are multiple tags passing through the monitored area. The determined tag locations for one or more tags can be identified and used by the timing system for various uses as described herein for an improved tag read as well ancillary event services. In such embodiments, one or more RFID tag readers receives a plurality of first and second tag reads, and for each determines a tag read time and a tag read parameter and transmits a tag read message containing each to the RFID tag location system. The RFID tag location system receives the plurality of tag read messages with the plurality of first and second tag reads, first and second tag read times and first and second tag read parameters. With these the RFID tag location system performs a plurality of comparing and determining processes to determine a plurality of tag positions of the RFID tag within the coordinate system, each determined tag position being different. One such use of known a plurality of positions of a particular one or more of the tags is that the system can use the multiple determined positions for features such as determining a velocity, speed, direction or relative position of a particular RFID tag within the coordinate system and therefore on the route 140 and in relation to one another and in relation to the detection system 144 or other system components such as video capture devices located along the route 140. In some embodiments, one RFID tag and its determined position can be differentiated from that of a RFID tag and such differentiation utilized by the timing system for determining a time, velocity, time of passing or relative position of one RFID tag relative to the other.

In some embodiments, one RFID tag and its determined position can be differentiated from that of a RFID tag and such differentiation utilized by the timing system for determining a time, velocity, time of passing or relative position of one RFID tag relative to the other.

In some embodiments, the RFID tag location system includes an output interface transmitting a remote action control message to a communicatively coupled system responsive to the determined tag position. This remote action control message can be used to initiate an action by the remote system responsive to transmitted remote action control message. By way of example, the remote system can be an image capture system that is configured to captures an image response to the received remote action control message. This can further be configured so that the control message includes the determined tag position within the coordinate system. In such embodiments, the image capture system can directs the capturing of the image in an area corresponding to the received determined tag position, such as by controlling a camera to take a picture or video of a particular participant associated with the RFID tag. When more than one determined position for the tag is provided, the camera can be controlled to follow the participant and take moving pictures or a stream of still picture and focused on the one particular participant. In another embodiment the remote system can be a biometric system that initiates the capturing of biometric data associated with the RFID tag response to the received remote action control message and the identification of the position of the RFID tag relative to a biometric receiving module.

In other embodiments a system is provided for determining a time of passing of a participant in a timed event having an RFID tag with a unique tag identifier with the timed event having a monitored area having a predefined X, Y, Z coordinate system and the monitored area of the timed event having a monitored line defined within the monitored area coordinate system. A tag reader is communicatively coupled to a first RFID antenna having a first antenna identifier and a second RFID antenna having a second antenna identifier with each positioned proximate to the monitored area and spaced apart from each other. The tag reader receives a first RFID tag read with the tag identifier from the first RFID antenna and a second RFID tag read with the tag identifier from the second of the

RFID antenna. The tag reader determines a first tag read time and a first tag read parameter associated with the received first tag read and determines a second tag read time and a second tag read parameter associated with the received second tag read. The reader transmits a first tag read message including the tag identifier and the first tag read time, the determined first tag read parameter, and the first antenna identifier over an output interface and transmits a second tag read message including the second tag read time, the determined second tag read parameter and the second antenna identifier over the output interface.

An event timing system receives the first tag read message and the second tag read message from the tag reader and compares the determined first tag read parameter with the determined second tag read parameter as received in the first and second tag read messages. The timing system then determines a tag position of the RFID tag within the coordinate system of the monitored area as a function of the comparing. The timing system determines a relative Y distance position of the RFID tag from a comparison of the Y coordinate of the determined tag position within the coordinate system and a Y coordinate of the defined monitored line. The timing system then determines the time of passing of the RFID tag past the monitored line when the determined relative Y distance position is about zero and as a function of the tag read time in the tag read message associated therewith.

In other embodiments, a method is provided for identifying a geographic location of an RFID tag with a unique tag identifier within a monitored area having a predefined X, Y, Z coordinate system. The method includes processes performed in a tag reader having a computer, a memory, an output interface and an input interface that is communicatively coupled to a first RFID antenna having a first antenna identifier and a second RFID antenna having a second antenna identifier with each positioned proximate to the monitored area and spaced apart from each other. The tag reader processes include receiving a first RFID tag read with the tag identifier from the first RFID antenna, receiving a second RFID tag read with the tag identifier from the second of the RFID antenna, determining a first tag read time and a first tag read parameter associated with the received first tag read, determining a second tag read time and a second tag read parameter associated with the received second tag read, and transmitting a first tag read message including the tag identifier, the first tag read time, the determined first tag read parameter, and the first antenna identifier and a second tag read message including the tag identifier, second tag read time, the determined second tag read parameter and the second antenna identifier over the output interface.

The method also includes processes performed in a RFID tag location system. Those processes include receiving the first tag read message and receiving the second tag read message. The process also includes comparing the received first tag read parameter with the received second tag read parameter and determining a tag position of the RFID tag within the coordinate system of the monitored area as a function of the comparing.

In some embodiments, the method can include comparing the received first tag read time with the received second tag read time as received in the first and second tag read messages, and wherein the determining of the tag position of the RFID tag within the coordinate system of the monitored area is further a function of the comparing of the first and second tag read times.

In some embodiments, the method can include a monitored line and determining a time of passing of the RFID tag past the monitored line responsive to the determined tag position and at least one of the first tag read time and the second tag read time.

In some embodiments, the method can include determining the first tag read parameter as a first RF signal strength of the first tag read and determining the second tag read parameter as a second RF signal strength of the received second tag read.

The method for determining the position of the RFID tag can be any suitable system and is typically provided by computer executable instructions. These can be configured for triangulation for the performing of the comparing and determining In other embodiments, the tag read parameters and the processes of comparing and determining can include one or more of a signal strength of the received RF tag read, a relative radio frequency sign strength of the RF tag read, an RF polarization, a RF polarization shift, a phase of the received RF tag read, a phase shift of the received RF tag read, a propagation delay of the RF tag read, a Q value of the RFID tag, a signal strength of a tag read request or wakeup message sent from an antenna and as received by the RFID tag.

In some embodiments, the method can includes defining a first antenna pattern for the first antenna within the monitored coordinate system, defining a second antenna pattern within the monitored coordinate system, and then determining of the tag position as a function of comparing the first tag read parameter to the first antenna pattern and the second tag read parameter to the second antenna pattern.

In some embodiments, the method can include defining the first antenna pattern as a three dimensional antenna radiation pattern of antenna radiation energy levels and defining the second antenna pattern as a three dimensional antenna radiation pattern of antenna radiation energy levels. In such embodiments, the determining the first tag read parameter as a signal strength of the first tag read and determining the second tag read parameter as a signal strength of the second tag read can include associating the first tag read parameter with the first antenna pattern and associating of the second tag read parameter with the second antenna pattern.

In some embodiments, the method can include, the RFID tag location system can store each of the first and second tag read messages including the first and second tag read times, and determine a duration of the RFID tag within each of the first antenna pattern of the first antenna and the second antenna pattern of the second antenna. In such embodiments the process of determining of the tag position is at least in part based on a comparing of determined tag duration in at least one of the first and second antenna patterns.

In some embodiments, the method can include positioning the first antenna at the first antenna position, and calibrating the first antenna radiation pattern of the first antenna before, during or after the positioning of the first antenna with a first calibration parameter. The method can also include positioning the second antenna at the second antenna position, calibrating the second antenna radiation pattern of the second antenna before, during or following the positioning of the second antenna with a second calibration parameter. Each of these can be store antenna calibration parameters in the memory of the RFID tag location system and can therein be utilized in the determining of the tab position. This process can include positioning and calibrating of the first antenna so that the first antenna pattern overlaps at least a portion of the second antenna pattern. This can also include positioning and calibrating of the first antenna and the second antenna to ensure that there are no null points within the monitored area.

In some embodiments, the method can include the positioning and calibrating of the first antenna and the second antenna provide for the first antenna pattern at least partially overlapping the second antenna pattern so that all coordinate points within the coordinate system of the monitored area are within at least one of the first antenna pattern and the second antenna pattern.

In some embodiments, the method can include calibrating of the first antenna that includes setting a first frequency for the first antenna for transmitting a first tag read request and the receiving of the first tag read is at the first frequency and the calibrating of the second antenna that includes setting a second frequency for the second antenna for transmitting a second tag read request and the receiving of the second tag read is at the second frequency. These frequencies can be different frequencies or can varying over time.

In some embodiments, the method can include providing a first tag read request to the first antenna, providing a second tag read request to the second antenna and transmitting from the first antenna a first tag read message to the RFID tag responsive to receiving the provided first tag read request. This can include thereafter receiving of the first tag read responsive to the first tag read message. This can also include transmitting from the second antenna a second tag read message to the RFID tag responsive to receiving the provided second tag read request and the receiving of the second tag read is responsive to the second tag read message.

In some embodiments, the method can include providing from the tag reader the first tag frequency with the first tag read request and providing from the tag reader the second tag frequency that is different from the first tag frequency with the second read request.

In some embodiments, the method can include the process at the tag reader of determining a first antenna transmit parameter for the first antenna and transmitting a first tag read message using the determined first antenna transmit parameter. This can also include determining a second antenna transmit parameter for the second antenna and transmitting the second tag read message using the determined second antenna transmit parameter. Thereafter the transmitting the determined first antenna transmit parameter with the first tag read message, and the transmitting the determined second antenna transmit parameter with the second tag read message are performed. The method includes determining the tag position within the coordinate system by the RFID tag location system as a function of the received first antenna transmit parameter and the received second antenna transmit parameter.

In one embodiment a method is provided for determining a time of passing of a participant in a timed event having an RFID tag with a unique tag identifier with the timed event having a monitored area having a predefined X, Y, Z coordinate system and the monitored area of the timed event having a monitored line defined within the monitored area coordinate system. The method includes processes performed in a tag reader having a computer, a memory, an output interface and an input interface with the input interface being communicatively coupled to a first FRID antenna having a first antenna identifier and a second RFID antenna having a second antenna identifier with each positioned proximate to the monitored area and spaced apart from each other. These processes include receiving a first RFID tag read with the tag identifier from the first RFID antenna and receiving a second RFID tag read with the tag identifier from the second of the RFID antenna. It also includes determining a first tag read time and a first tag read parameter associated with the received first tag read and determining a second tag read time and a second tag read parameter associated with the received second tag read. The process includes transmitting a first tag read message including the tag identifier and the first tag read time, the determined first tag read parameter, and the first antenna identifier and a second tag read message including the second tag read time, the determined second tag read parameter and the second antenna identifier over the output interface.

The method further includes processes performed in an event timing system. These processes include receiving the first tag read message and receiving the second tag read message. This also includes comparing the determined first tag read parameter with the determined second tag read parameter as received in the first and second tag read messages and determining a tag position of the RFID tag within the coordinate system of the monitored area as a function of the comparing. The process further includes determining a relative Y distance position of the RFID tag from a comparison of the Y coordinate of the determined tag position within the coordinate system and a Y coordinate of the defined monitored line. This further includes determining a time of passing of the RFID tag past the monitored line when the determined relative Y distance position is about zero and as a function of the tag read time in the tag read message associated therewith.

In various embodiments, one or more of the following systems alone or in combination: a) the tag read data from each antenna includes a signal strength of the received tag read from the RFID tag; b) the tag read data from each antenna includes a relative signal strength of the received tag read from the RFID tag; c) the tag reader adjusts the transmit power of the tag reader during the tag reading process of one or more antenna; d) the tag read data from each antenna includes a phase shift of the received tag read from the RFID tag; and e) the tag reader adjusts the rate of tag reads by one or more of the antenna based on the signal strength of the received tag reads.

This can also include f) the tag reader ignores certain detected tags and prioritizes the reading of the tag from among a plurality of detected tags among the plurality of antenna; g) the timing system stores each of the tag reads including the time of each tag read and determines a duration of the tag in an RF field of each antenna, wherein the determination of location is based at least in part on a comparison of the tag duration in the RF field of one or more antenna; h) the tag read data from each antenna includes a signal strength or relative signal strength of the received tag read from the RFID tag and wherein determining the location is also based on the signal strength or the relative signal strength; i) the tag read data from each antenna includes a signal strength or relative signal strength of the received tag read from the RFID tag and wherein the RF field of each antenna is determined at least in part based on the signal strength or relative signal strength; and j) the RF field of each antenna is predefined and/or the RF field of one or more antenna is calibrated prior to the event and stored in a memory of the timing system.

This can further include k) the antenna are configured and positioned so that the RF fields of two or more antenna overlap and at least two antenna are reading the same RFID tag; 1) the antenna are configured and positioned so there are no null points along the monitored portion of the route; m) the antenna are configured and positioned so that the RF fields of all of the antenna overlap and at all points of the monitored portion of the route all of the antenna are reading the RFID tag; n) the determined position/location of the RFID tag is the Y distance between the RFID tag and the monitored point; o) the antenna are positioned at the monitored point or spaced apart therefrom; p) the determined position includes the X distance which is the lateral position of the RFID tag across a width of the route being monitored or the monitored line; and q) the determined position includes the Z distance of the RFID chip above the surface of the route.

This can also include r) the antenna are configured and positioned so that the RF fields of two or more antenna overlap and at least two antenna are reading the same RFID tag; s) the antenna are configured and positioned so there are no null points along the monitored portion of the route; t) the antenna are configured and positioned so that the RF fields of all of the antenna overlap and at all points of the monitored portion of the route all of the antenna are reading the RFID tag; u) the a RFID tag reader system communicates with the RFID tag and obtains the RFID tag number of the RFID tag in a plurality of RFID tag reads by each of the antenna, and time stamps each RFID tag read as the tag read, and transmits over a communication interface a tag read message including the RFID tag number and the time stamp to the timing system; v) there are two or more tag reader systems configured as disclosed above, each of which is communicatively coupled to the timing system, wherein the timing system determines the location of the RFID tag based on the tag reads and tag read data of the antenna of each of the tag reader systems; w) the two or more tag reader systems are space apart along the route, but wherein RF fields of the antenna of each tag reader systems overlap; x) the antenna of the two or more RFID readers are configured and positioned so that the RF fields of two or more antenna of each RFID reader overlap and at least two antennas from each RFID reader are reading the same RFID tag; y) the antenna of the two or more RFID readers are configured and positioned so there are no null points along the monitored portion of the route; and z) the antennas of the two or more RFID readers are configured and positioned so that the RF fields of all of the antenna of each RFID reader overlap and at all points of the monitored portion of the route all of the antennas of each tag reader are reading the RFID tag.

In other embodiments, a method for determining a time of a passing of a participant passed a monitored line on a route based on a determined location from a plurality of RFID tag reader antenna, the method comprising the processes of claim 1 in one or more combinations of the processes of the below recited claims 2-25 or as further disclosed and supported by this specification including one or more of the figures, alone or in view of the specification text.

In or more embodiments, the disclosed Multi-Path RFID Tag Location System is a design solution that utilizes both hardware and software to address these problems with sports timing systems. The design utilizes multiple antennas mounted at a timing location working independently and reading tags within an expanded RF field. Each antenna provides overlapping coverage of the desired tag read zone. Thus, multiple antennas can provide more reliable coverage of the RF field and the information reported from the antennas includes, but is not limited to, total reads for an individual tag, as well as the signal strength for each tag read. This information can be analyzed using software algorithms that can then determine the specific location of the tag, using techniques of triangulation, with a high degree of reliability.

The advantages of the Multi-Path RFID Tag Location System are significant and include the following: (1) there is no single point of failure because the design provides overlapping antenna RF field coverage; (2) the design make it possible to triangulate on the position of a tag to determine its relative position.; (3) the design greatly reduces the occurrence of any null spots in the RF field; (4) the design provides more electrical energy to tags passing through the timing point, thus improving the chances of a passive RFID tag harnessing the electrical energy needed to function properly; (5) the design provides greater coverage of tags contained in any single location within the RF field; (6) the design makes it possible to determine the velocity of a tag within the RF field; (7) the design improves the ability to read tags which may not be in the same polarization plane as desired; (8) the design makes it possible to identify tags approaching the timing location, prior to them actually arriving; and (9) the design provides greater flexibility for the physical configuration of a timing location because the antennas do not have to be placed on the ground, which has been the typical method employed by most legacy sports timing systems in the past.

The Multi-Path RFID Tag Location System for Sporting Events has been tested extensively and has shown that it is capable of delivering consistent read rate accuracy above 99.5%. This is significant given that a single system employing 4 antennas can be used. In addition, this level of read rate reliability can be accomplished with a passive RFID tag that costs less than 30 cents to manufacture.

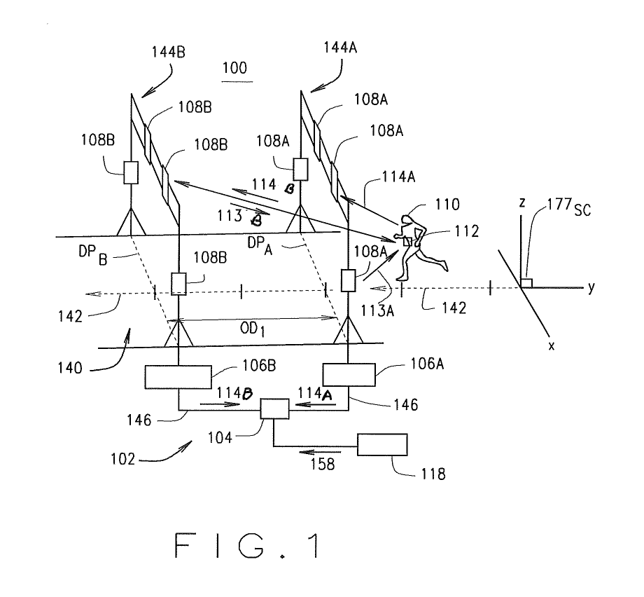

Referring now to the Figures, FIG. 1 is an RFID tag location system 100. As will described herein the RFID tag location system 100 is illustrated herein by way of example as being an event participant management system 102 with a timing system 104. However, it should be understood that this is only by way of example as the RFID tag location system 100 can be used in other industries and applications having one or more RFID tags whose position needs to have a location detected. In this example, a timing system 104 acts and performs many of the functions described and claimed herein as the location detection system but this is only by way of example and other systems can implement some or all of the functions and features described herein by way of example with the timing system 104.

As shown, the timing system 104 includes one or more tag readers 106 each with multiple antennas 108. A participant 110 or an RFID tag 112 travels along event course 140 and participant travel path 142 therein and traveling at a speed of VA. The area shown is referred to as the monitored area having coordinate system 177SC. While coordinate system 177SC is shown on the side, the X=0, Y=0 and the Z=0 center of the coordinate system 177SC can be located at any position, whether within the monitored area or by way of means of GPS or latitude and longitude positions or any other coordinates that may be suitable. Generally, the coordinate system once selected is common to all systems and processes regardless of where located, or if not common, at least associable between one defined position with a first coordinate system and a second defined position in a second coordinate system for a common point.

The participant 110 typically has an RFID tag 112 (sometimes referred as a chip) that has a unique tag identifier 134. Of course the RFID tag 112 does not need to be associated with a participant 110 but can be by itself or associated with a vehicle, package or the like. As shown in FIG. 1, the system 100 can include more than one detection points DPA and DPB that are spaced apart by distance OD1. Timing point DPA is monitored by detection system 144A using tag reader 106A and antennas 108A and timing point DPB is monitored by detection system 144B using tag reader 106B using antenna 108B. Each tag readers 106A and 106B (referred commonly as tag reader 106) using the antenna 108A and 108B, respectively (referred commonly as antenna 108) obtains one or more RFID tag read message 114 (referred herein shortened as tag read 114) that includes the tag identifier 134 from the tag 112. These are often in response to the tag reader 106 transmitting via an antenna 108 one or more tag read request 113 such as shown as tag read requests 113A and 113B, and transmits over link 146 the received tag identifiers 134 to the timing system 104 as the participant 110 traverses along path 142. The tag readers 106 further have a clock and determine a tag read time which is also transmitted with or within tag reads 114 to the timing system 104.

As shown the timing system 104 is coupled to both tag readers 106A, 106B, with the first detection system 144A being located along course 140 at point DPA and includes a plurality of antenna 108A coupled to tag reader 106A. A second detection system 144B is located along course 140 at point DPB that includes antenna 108B coupled to tag reader 106B. Point DPA is spaced apart from point DPB at a distance OD1 along course 140. Distance OD1 can be only few feet or can be split points such as miles or kilometers apart along course 140, such as a start line, a split point or a finish line, by ways of example. Each tag read 114 and tag read time is correlated to the particular detection system 114A and 114B that can also be provided to an administration system 118. The administration system 118 can also provide location data requests 158 to the timing system 104 such as a request to provide any known current or past position of a particular RFID tag 112.

As shown, as the participant 110 with RFID tag 112 approaches and passes each of points DPA and DPB, each detection system 144A, 144B receives one or more tag reads 114 from the RFID tag 112 using tag readers 106A, 106B and transmits each tag read 114 and the tag read times to the timing system 104 via communication link 146. A participant registration system 118 is communicatively coupled to timing system 104 for providing participant information such as registration information, assignment of a unique tag identifier 134 to each RFID tag or registered participant 110 and therefore assignment of each RFID tag 112 (or tag identifier 134) to each participant 110. Furthermore, the participant registration system 118 can provide other features and participant data 158 such as requests for desired tag/participant locations or positions as to the progress or status of the participant 110 or tag 112 that can include the identification of determined geodetic positions as will be described or one or more virtual detection points VDP that may define for the particular tag 112 along route 140 and/or the participant path 142 traveled by the participant 110 along the route 140 as will be further described herein.

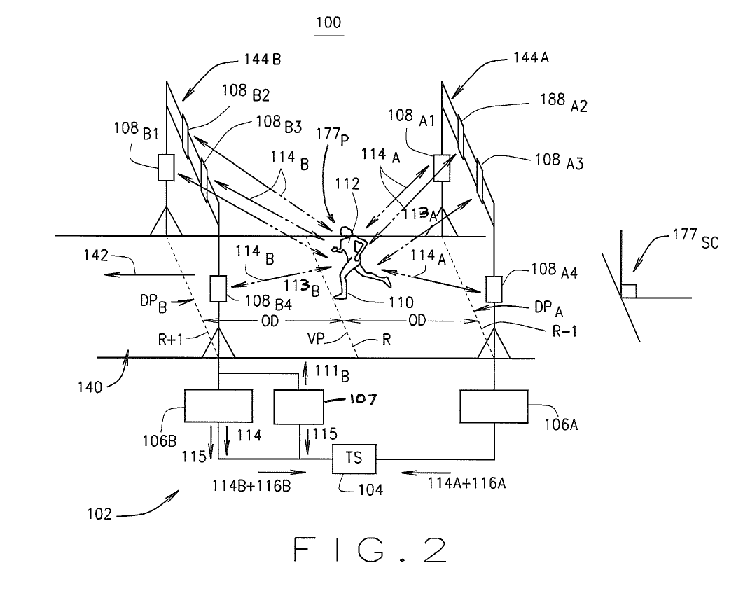

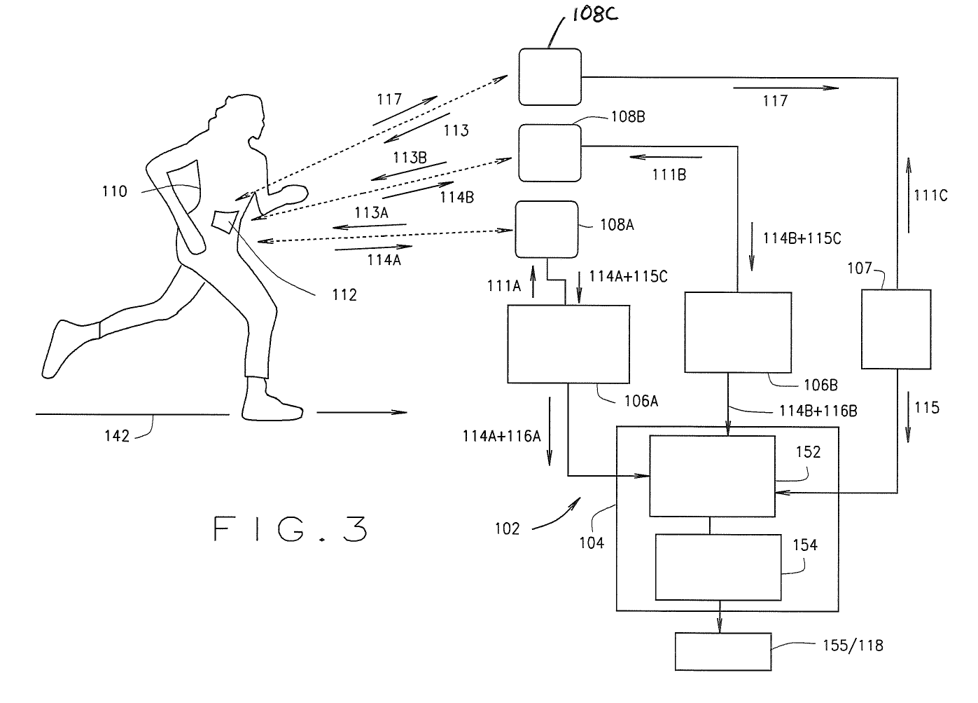

FIGS. 2 and 3 is an RFID timing system 100 having two RFID tag reader 106A, 106B each multiple antennas 108A1, 108A2, 108A3, 108A4 for tag reader 106A and 108B1, 108B2, 108B3 and 108B4 for tag reader 106B. Each are for transmitting tag read requests 113 and 115 from one or more of their antenna 108 and obtaining in response one more tag reads 114 shown by way as example tag reads 114A and 114B. Along with these tag reads 114A and 114B, additional data 117 can be transmitted by RFID tag 112. In this example, a location detection transceiver 107 can transmit a request 111B to one or more of the antenna 108B and also obtain or determine tag read parameter 115 associated with one or more tag read 114 or an antenna 108B. Further, tag readers 106A, 106B also provides tag read parameters 115 and 116, shown by way of example as 116A and 116B. FIG. 2 illustrates the timing system 104 receiving the tag reads 114A, 114B and the tag read parameters 116A, 116B, as well as, where available, tag or antenna parameter 115. From these, described herein, the current position 177P of the RFID tag 112 associated with participant 110 can be defined within the coordinate system 117SC.

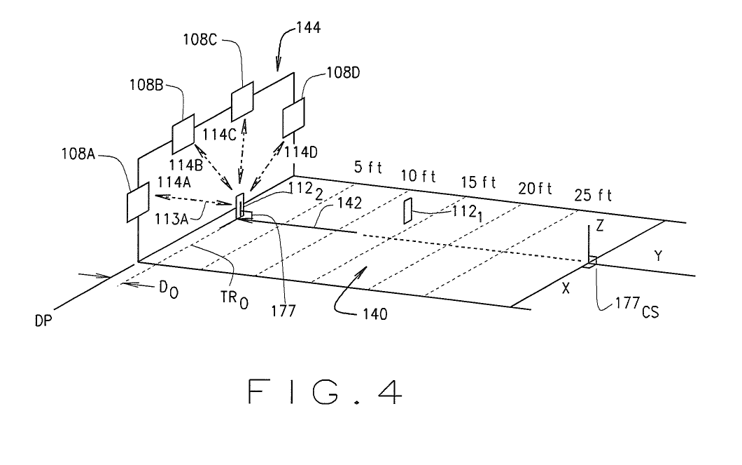

FIGS. 3 and 4 illustrates that the system 102 includes the timing system 104 with RFID location detection module 152 receiving the tag reads 114A, 114B and the tag read parameters 116A, 116B as provided by the tag readers 106A, 106B. Further, location detection receiver 107 which may not be a tag reader but a standalone location detection system or module, can also monitor and receiver tag read data 117 that can also be provided to the location detection module 152. As will be described, the location detection module 152 determines the location or tag position of the tag 112 within the coordinate system as described herein. Further, the timing system 152 can have a separate or integrated timing of passing module 154 that determines the time of passing of a tag based on the determined position as provided by location detection module 152. The timing system can also output the determined tag position to an external tag location or tracking system 155 or to the participant registration system 118. FIG. 4 is a schematic drawing of a route 140 having a detection point 144 with four RFID antenna 108A, 108B, 108C and 108D positioned across a width or lateral of the detection point 144 for detecting the RFID tag 112 as it travels path 142 of route 140. The route 140 has the coordinate system 177CS. As shown in FIG. 4, the four antennas 108 provide sufficient coverage for a typical timing location varying in width from 1 to 15 feet. Additional width could be supported by incorporating more antennas. As shown in the drawing, each antenna is capable of reading the RFID tag as it passes through the timing point. One of the advantages provided by this design is the ability to read a tag regardless of the orientation of the tag within the field. In testing, it has been shown that a typical RFID tag can be read when it is oriented vertically, diagonally, or horizontally. This occurs because each of the antennas provides a unique RF read zone that is polarized slightly different than the other antennas. In addition, the orientation of each antenna can be easily changed with this design to accommodate unique tag read zones for different types of events. Thus, the configuration shown is not intended to be limiting in any way. The configuration could be changed to incorporate antennas that are placed only on the sides of a course or placed on the ground.

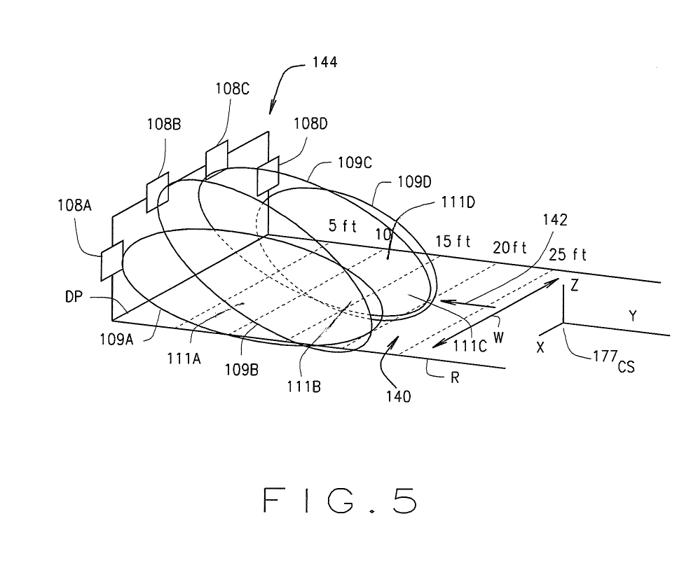

FIG. 5 is a schematic drawing showing a location detection system 144 having four antennas 108A, 108B, 108C and 108D having antenna fields or patterns 109A, 109B, 109C and 109D, respectively. As shown the antenna patterns 109A, 109B, 109C and 109D collectively cover the entire monitored area and have multiple overlapping antenna areas 111A, 111B, 111C and 11D providing duplicated coverage and ensuring null spot elimination over the monitored area and across the full width W.

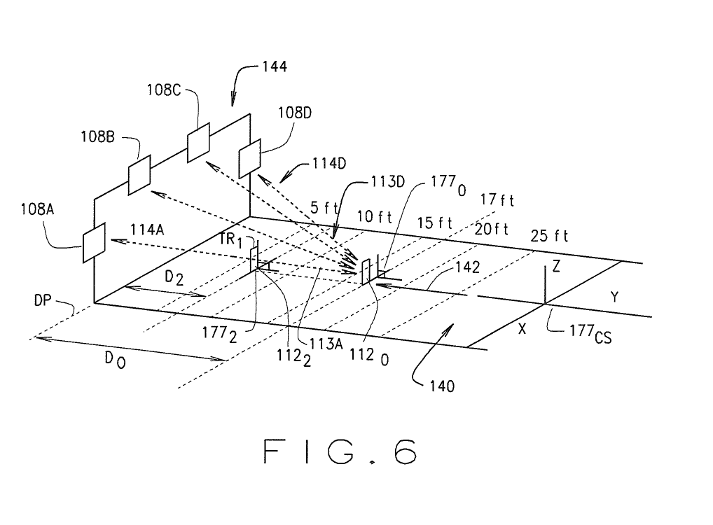

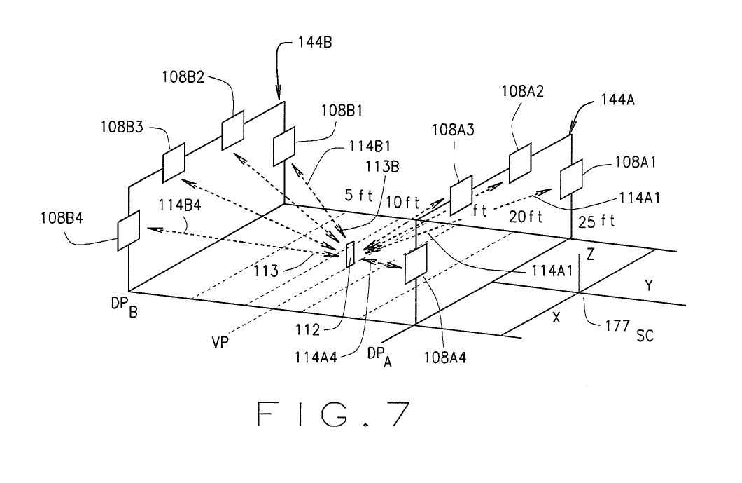

FIGS. 6 and 7 are schematic drawing illustrating tag reading of an RFID tag moving within the monitored area and the determination of two positions 177ₒ and 177₂ of RFID tag 112 at two advanced spaced apart locations prior to or approaching the location detection system 144 and detection point DPO. This can be used for determining the Y position of the FRID tag 112 relative to a monitored line DP in such coordinate system 177SC.

In various embodiments, variations of FIG. 7 are possible. As shown in FIG. 6, an RFID tag position in a coordinate system (X, Y, Z) can be positioned at two advanced spaced apart locations prior to or approaching the monitored point with four RFID antenna for determining at least the Y position of the tag in such coordinate system which is the distance from the tag to the monitored point according to one embodiment. There is shown the schematic drawing of the design incorporating four RFID antennas on a structure at a timing location. The four antennas have a read range sufficient to begin communicating with a tag at a distance of up to 25 feet away. As shown in this drawing, a tag is being read approximately 18 feet away from the antennas. As the tag approaches the antennas, the position of the tag relative to each antenna will be read numerous times by each antenna. The time the position is read is also recorded. The position and time information is gathered at high-speed and used to determine the velocity of the tag by comparing the reads over a period of time. FIG. 7 differs from FIG. 6 in that there are two different detection systems 144A and 144B having spaced apart RFID antennas 108A1, 108A2, 108A3 and 108A4 associated with detection system 144A and RFID antennas 108B1, 108B2, 108B3 and 108B4 associated with detection system 144B. In this embodiment, virtual point VP is determined that is between detection point DPA and DPB.

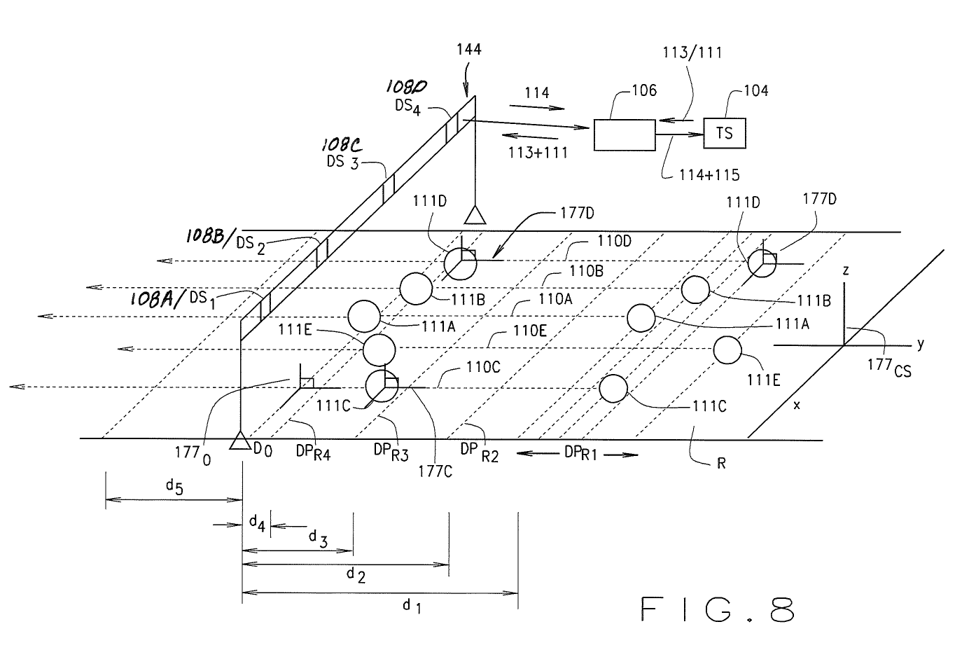

FIG. 8 is a schematic drawing of a monitored area having a wide width and having a plurality of RFID tags 112A, 112B, 112C, 112D, 112E traveling a route 140 and approaching detection system 140 with antenna (DS) 109A, 108B, 108C and 108D, shown as DS1, DS2, DS3 and DS4. The actual tag positions over travel time are shown by the multiple instances of 111A, 111B, 111B, 111C, 111D and 111E and the determined positions with the coordinate system are shown as positions 177D, 177D, and 117C. The position of the finish line is shown at DO and having a coordinate position of 177).

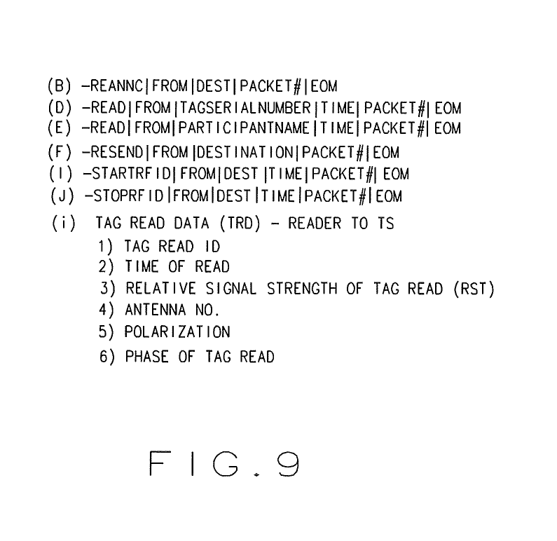

FIG. 9 is a listing of communication messages and formats including messages for reading RFID tag data, obtaining tag reads and for controlling the reading of the RFID tags, and transmitting tag read parameters as determined by a tag reader according to some embodiments of the disclosed system and method. As shown, these can include resending of the tag read, starting the reading of tags, stopping the reading of tag, and tag read data that include the tag identifier, the time of the tag read, the relative strength of the tag read, the antenna number or identifier, the polarization of the received tag read and the phase of the tag read. These are only by way of example and not intended to be limited thereto.

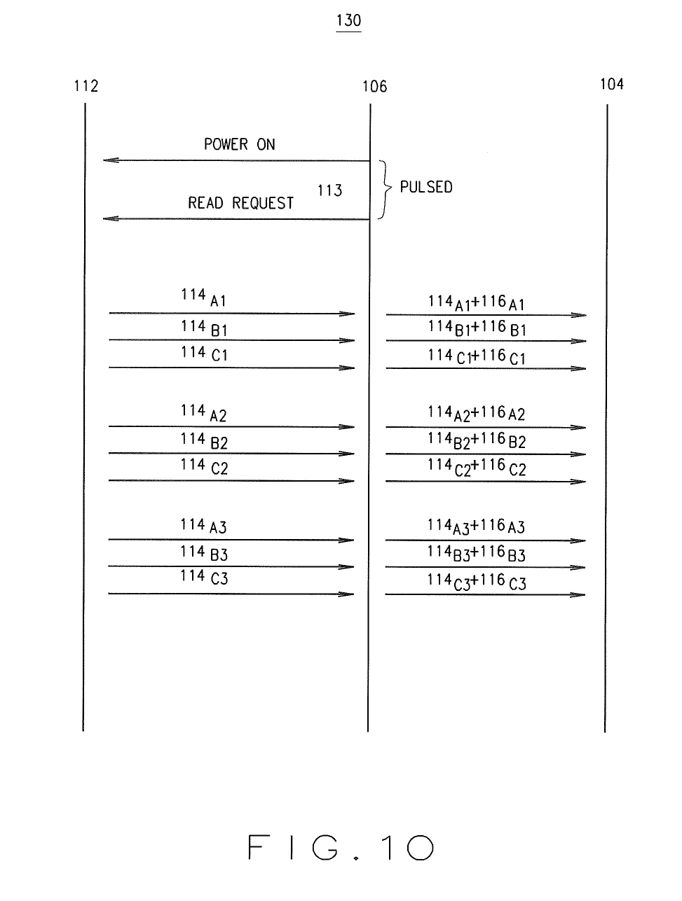

FIG. 10 is a timing diagram 130 of a process for tag reading of timing data by a tag reader 106 and transmission of the tag read 114 with the determined tag read parameter data 116 to the timing system 104 according to one embodiment. As shown, the tag reader 106 transmits a power on and read request message as 113. The tag 112 transmits a plurality of tag reads to each of antenna A, B, and C at a first location as tag reads 114A1, 114B1 and 114C1. The tag reader receives each of these first location tag reads and determines a tag read parameter 116A1, 116B1 and 116C1 associated with each respectively. As the tag moves, the same antenna take tag reads at position 2 and 3. At position or read time 2, the tags transmit tag reads 114A2, 114B2 and 114C2. The tag reader receives each of these second location tag reads and determines a tag read parameter 116A2, 116B2 and 116C2 associated with each respectively. At position or read time 3, the tag 112 transmits tag reads 114A3, 114B3 and 114C3. The tag reader 104 receives each of these second location tag reads and determines a tag read parameter 116A3, 116B3 and 116C3 associated with each respectively. The tag reader 104 transmits each of these to timing system/tag location system 104 for use thereby.

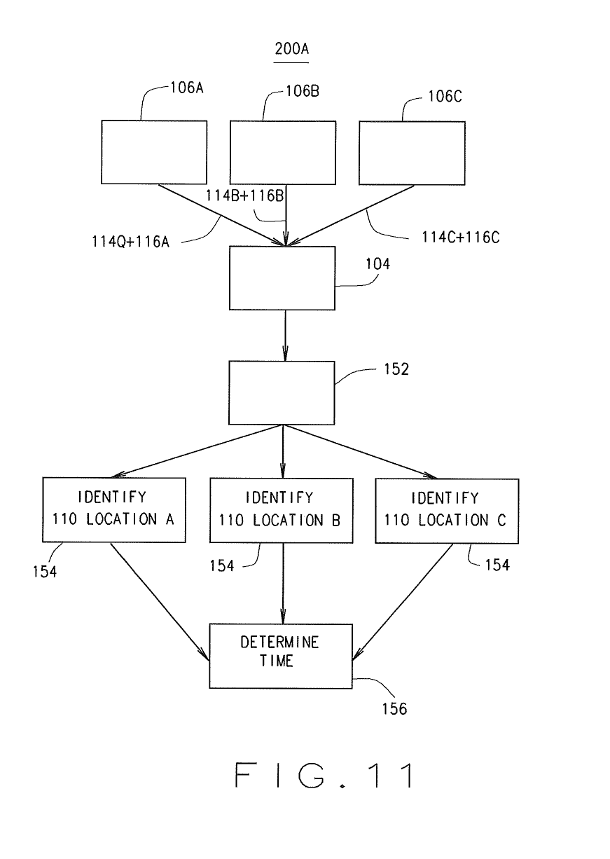

FIG. 11 is a flow diagram of a process 200A for determining a location of a RFID tag using multiple tag reads according to some embodiments. The tag readers 106A, 106B and 106C each provide their tag reads and tag read parameters to the timing system 104. This is provided to the location detection system 152 wherein each position location A, B, and C are determined ins 154. These positions from 154 are provided for determining the time in 156 by comparison or tracking or the like.

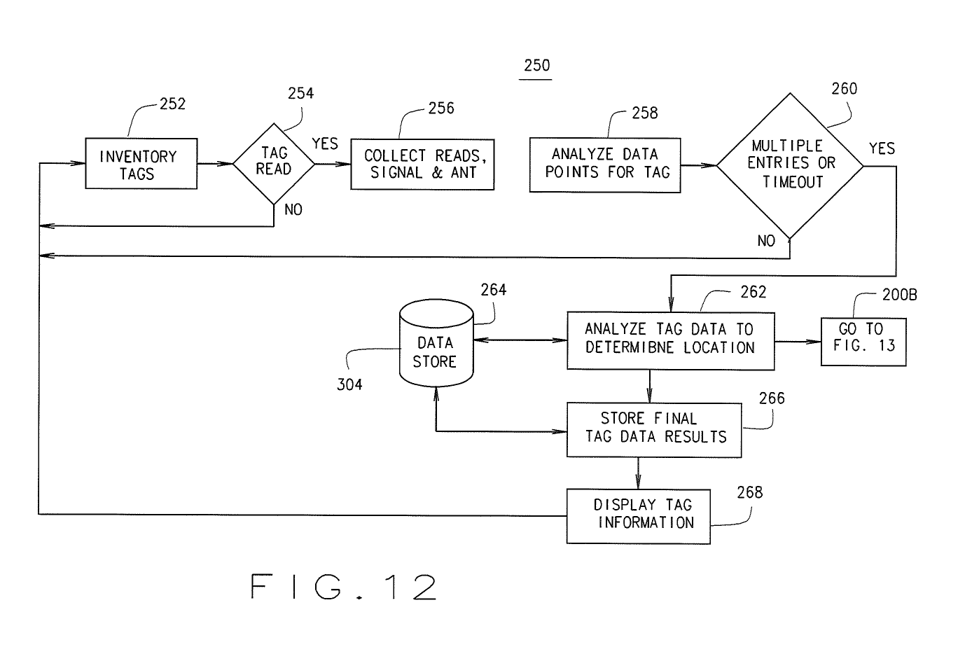

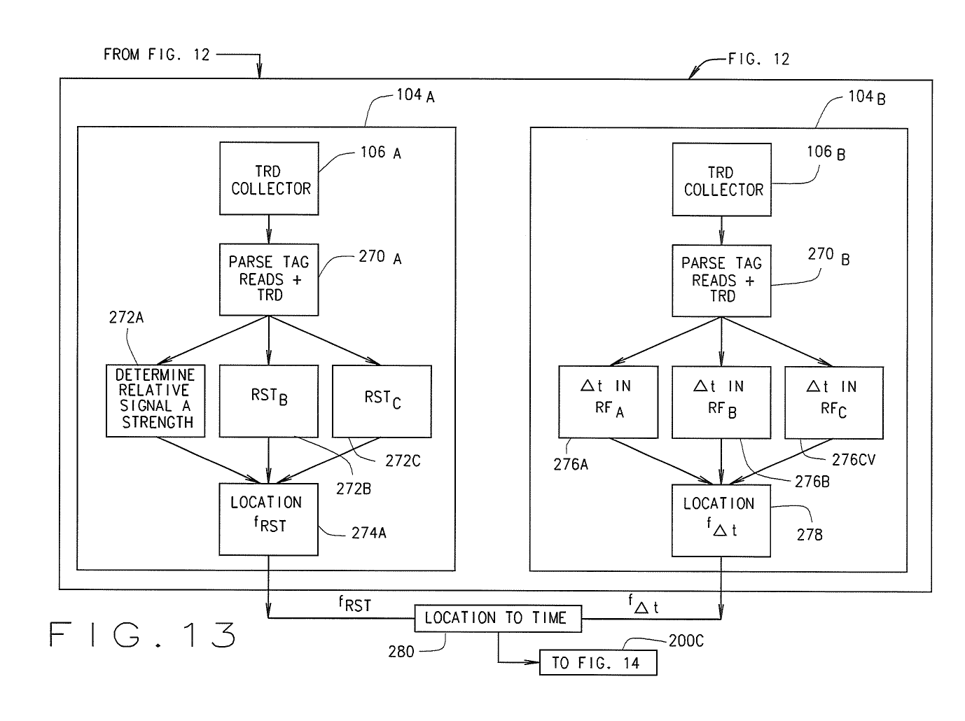

FIG. 12 is a flow diagram 250 for processing a plurality of RFID tag reads 112 from a plurality of RFID antennas 108 and determining one or more location 177 of the RFID tag 177 in a coordinate system and determination of the time of passing by a monitored point 144 within the monitored area according to one embodiment. This starts in process 252 with an inventor of tags that are within the read range of an antenna 108. The system determines in 254 whether a tag read has been successful and if so the system collects and reads the tag read parameter in process 265. If not, the system continue to inventory the tags 112 within the monitored area. After receiving the tag reads 112 and the tag read parameters in 258 the system analyzes the data points for a tag 112 in process 258 and identifies whether there are multiple entries or a time out condition in process 260. In so, the process moves to analyze the tag data to determination the tag position or location in process 262 and stores that determined position in data store 304 in process 264. The process than stores final tag data results in process 266 and can provide for a display or output of the tab information in process 268. After the tag position is determined, the process can continue in 200B as shown in FIG. 13. These processes can be further described as follows:

Inventory (Process 252): The system will constantly execute a procedure that look for new tags entering the RF field of each antenna. Once a tag is identified at an antenna, the tag will be read by that antenna and stored in memory.

Tag Read (Process 254): The system will constantly execute a procedure which determines if a new tag read has been stored in memory. If so, it prepares the information that was collected by process (A) and stored in memory, and it passes that information to process (C).

Collection (process 256): This process will examine the information collected and determine the total number of reads that occurred, the signal strength of each read, and the antenna that processed each read. This information is then written to a data storage location for future analysis.

Analyze Data (process 258): This process will perform an analysis to determine if the tag read data is valid and conforms to the specifications for the system. This is done to ensure that the tag is not a foreign tag that is not compatible with the system. In addition, this process determines if this is the first read for a valid tag, or if it is not the first read.

Multiple Entries or Timeout (process 260): If the tag was seen for the first time, and the timeout for this tag read has not occurred, this process is terminated and control returns to the inventory tag process (A). This is done because the system needs to wait for at least one more read for that tag. The additional read is what allows the system to determine the specific location with a higher level of accuracy. However, to ensure that all tags are processed in a timely manner, a timeout will occur if a second read for that tag does not occur in a set period of time, which is typically one to two seconds in duration. If a timeout occurs, the read location can still be computed, but the accuracy will not be as high as it would have been with a second read.

Analyze Tag Data (process 262): This process will retrieve the reads for the tag and determine the final time that is recorded for the location closest to the antennas. This information can be determined by analyzing all reads to determine the one with the strongest signal. In addition, triangulation of the final tag position can be accomplished by comparing the signal strengths and reads from multiple antennas that read the tag as it transitioned through the timing location.

Store Final Results (process 266): Once all computations are completed, the data will be stored to the data store for future retrieval.

Display Tag Information (process 268): The tag read information can be summarized and presented via a user interface to the operator of the system. Upon completion of this task, control returns to process (A).

FIG. 13 is a flow diagram 200B for processing a plurality of RFID tag reads 114 from a plurality of RFID antennas 108 and determination of the location or position of the tag 12 in a coordinate system 177 and determination of the time of passing according to one embodiment.

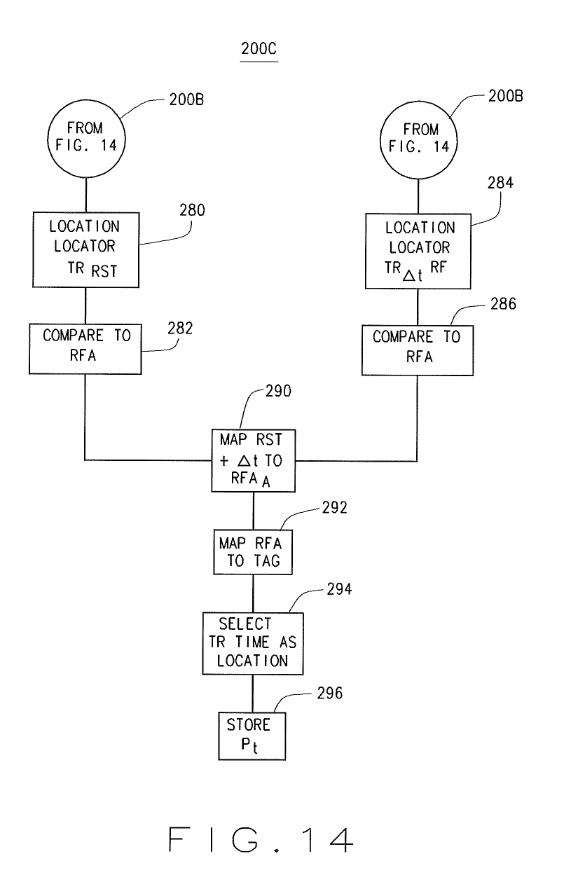

These include the tag reader 106A and 106B collecting the tag reads and then a parsing of the tag reads in 270A and 270B. For each parsed tag read 114 with its tag read parameter, a relative signal strength is determined for each tag read 114 in 272A, 272B and 272C. These are all analyzed in process 274A to determine a position or location of the tag 112 and a time is identified process 280 that is associated with the determined position. Process 104B is similar except after the tag reads 114 are parsed, a change in the time or delta time of the received radio frequency tag read for each tag read 114 is determined in processes 276A, 276B and 276C and these are utilized to determine a second determined location of the tag 112 in process 278. This second determined time is also provided to process 280 and the method continues in process 200C in FIG. 14. Both of the first and second tag positions are provided respectively to processes 280 and 284 to process 282 and 286. These are compared therein and provided to process 290 wherein they are mapped using the relative signal strength determined in process 272 and 274 and delta time as addressed above. Process 292 provides for mapping of the RFA to the tag 112 and in process 294 a time is selected as the time of the determined location or position of the tag 112. This determined time Pt is the determined time that the tag location was determined and is used for further processing as described herein.

As described, the presently disclosed system and method is an improved timing system that utilizes identifying of a location of the RFID tag within a coordinate system and utilizing the determined location for determining the time of passing of the participant past a monitored line that is within the same coordinate system. In this manner, the present system and method provides a more accurate determination of the actual point of passing of the participant past the monitored line than prior art RFID tag reader based timing systems.

### Exemplary Digital Processing System Environment

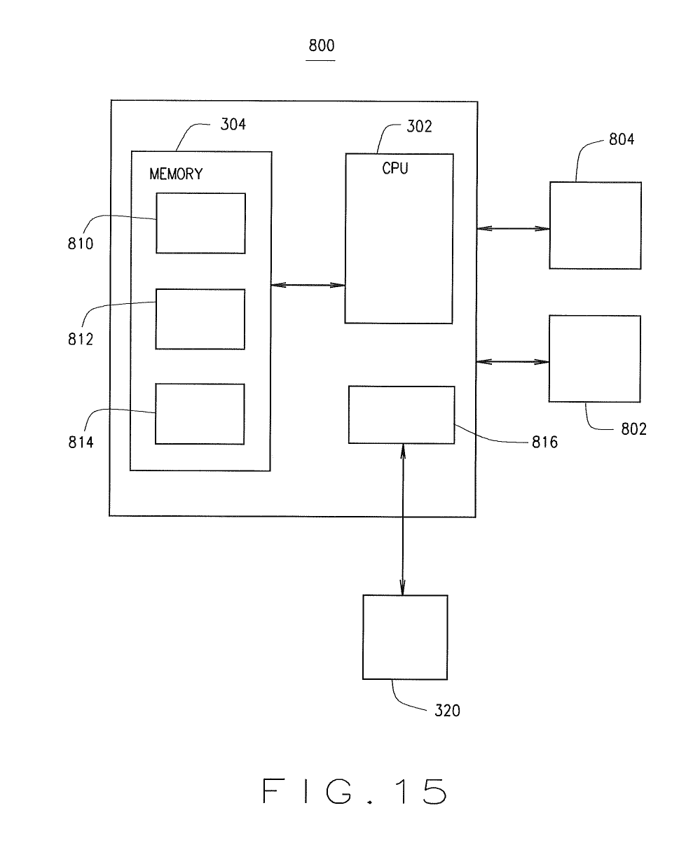

The systems, platforms, servers, applications, modules, programs, and methods described herein for the event participant management system 102 including the timing system 104 and the biometric module 122 among other components. Each of these can include one or more a digital processing systems 800 as shown in FIG. 15. Each component can include one or more hardware central processing units (CPU) 302 that carry out the functions as described above. The digital processing system 800 includes an operating system configured to perform executable instructions for the operation thereof. In most embodiments, the described digital processing systems 800 includes one or more memory devices 304, a display 802, one or more input devices 804, and in some embodiments can include a sound output device such as an alarm or status or verification signal. In some embodiments, the digital processing system 800 can be connected to one or more data networks 320 that can be a wired network, a mobile network, a wireless network such as a Wi-Fi or a Bluetooth™ network or a wired data network. These data networks 320 can be utilized to access the Internet or an intranet such as for accesses to the World Wide Web or other Internet based services. These can include, but are not limited to such data network accessible systems or applications such as a data storage device, a cloud service, an application server, a terminal or exchange server. In some embodiments, the digital processing system 800 is a non-portable device, such as a server or a desktop computer but in many embodiments it can be a portable device, such as a laptop, tablet computer, a mobile telephone device or a digital audio player.

The systems, platforms, servers, programs, and methods disclosed herein for one or more components or features of the system 100, the event management system 102, RFID reader 106, the timing system 104 or the biometric modules 116 and 122 can include one or more computer programs each of which are composed of sequences of computer executable instructions for the digital processing system's CPU each of which are developed to perform one or more specified tasks. Those of skill in the art will recognize that the computer program may be written in various computer programming languages having one or more sequence of instructions. The computer program can be loaded to the CPU 302 or associated memory 304 via a data network connection 320 or a local memory device, but are increasingly via a data network download. Typically, a computer program such as the operating system 810 is loaded by local memory device 304 such as CD or DVD. In some embodiments, the computer program is delivered from one location to one or more locations and can be increasingly distributed via a cloud computing or application service. In various embodiments, the computer program comprises, in part or in whole, one or more web, web browser, mobile, standalone or applications, extensions, add-ins, or add-ons, or combinations thereof. The systems, platforms, servers, programs, and methods disclosed herein above and throughout include, in various embodiments, software, server, and database modules. The software modules are created by techniques known to those of skill in the art using machines, software, and languages known to the art, some of which are disclosed above.

As noted, a digital processing system 800 typically includes one or more memory or data storage devices 304. The memory 304 stores data including the operating system 810 and application programs 812 as well as operating data 814 on a temporary or permanent basis. In some embodiments, the memory 304 can be volatile and requires power to maintain stored information but can also be non-volatile and retains stored information when the digital processing system 800 is not powered. Further, the memory 304 can be located with the digital processing systems 800 or can be attachable thereto either physically or via a data network connection to a remote memory 304. In some embodiments, the memory 304 can also include flash memory devices, solid state memory, magnetic disk drives, magnetic tape drives, optical disk drives, cloud computing systems and services, and the like.

As noted, the digital processing system 800 includes an operating system 810 configured to perform executable instructions which is stored in memory 304. The operating system can include software, including programs and data, which manages the device's hardware and provides services for execution of software applications/modules. Those of skill in the art will recognize that suitable operating systems can include, by way of non-limiting examples, Apple OS®, Microsoft® Windows®, Microsoft®, Windows®, Apple ® Mac OS X®, UNIX®, and UNIX-like operating systems such as GNU/Linux®. In some embodiments, the operating system can be provided by cloud computing. Those of skill in the art will also recognize that embodiments of the remote control panel and some components of the primary control panel system may also be implemented using suitable mobile smart phones that include mobile operating systems including, by way of non-limiting examples, Nokia® Symbian®, OS, Apple® iOS®, Research In Motion® BlackBerry OS®, Google® Android®, Microsoft® Windows Phone®, OS, Microsoft® Windows Mobile®, OS, Linux®, and Palm® WebOS®.

The digital processing system 800 can include a visual display 802. In some embodiments, the display 802 can be computer controlled cathode ray tube (CRT) or an optical projector, but is increasingly a flat screen such as a liquid crystal display (LCD), a plasma display, a thin film transistor liquid crystal display (TFT-LCD), a light emitting diode (LED) or an organic light emitting diode (OLED). In other embodiments, the display 802 can also be a combination of devices such as those disclosed herein. Typically they are located proximate to one of the digital processing systems 800 but in some embodiments, the display can be remotely located such as a billboard using LED or electrowetting technology.

The digital processing system 800 can also include one or more an input devices 804 that can be a push button, a key switch, a switch, a keyboard, a touch screen or keypad but these can also include a pointing device such as, by way of non-limiting examples, a mouse, touchpad, light pen, pointing stick, trackball, track pad, joystick, game controller, stylus, multi-touch screen, a microphone that captures voice or other sound inputs or an optical image capture device that can capture images or motion or other visual input. In still further embodiments, the input device 804 can be a combination of devices such as those disclosed herein.

In some embodiments, the digital processing system 800 optionally includes one or more sound output devices (not shown but known to those of skill in the art). These sound output devices can be a set of speakers, a pair of headphones, earphones, or ear buds. The speakers can be of any technology including a flat panel loudspeaker, a ribbon magnetic loudspeaker, an electro-acoustic transducer or loudspeaker or a bending wave loudspeaker, or a piezoelectric speaker. In still further embodiments, the sound output device can be a combination of devices such as those disclosed herein.

Such systems utilize one or more communications networks 320 can include wireline communications capability, wireless communications capability, or a combination of both, at any frequencies, using any type of standard, protocol or technology. In addition, in the present invention, communications network 320 can be a private network (for example, a VPN) or a public network (for example, the Internet). A non-inclusive list of exemplary wireless protocols and technologies used by communications network 320 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). An exemplary non-inclusive list of primarily wireline protocols and technologies used by communications network 320 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

In accordance with the description provided herein, a suitable digital processing system 800 can include, by way of example, server computers, desktop computers, laptop computers, notebook computers, tablet computers, mobile phones such as smart phones, audio devices, personal digital assistants, netbook computers, smartbook computers, subnotebook computers, ultra-mobile PCs, handheld computers, Internet appliances, and video game systems both portable and fixed.

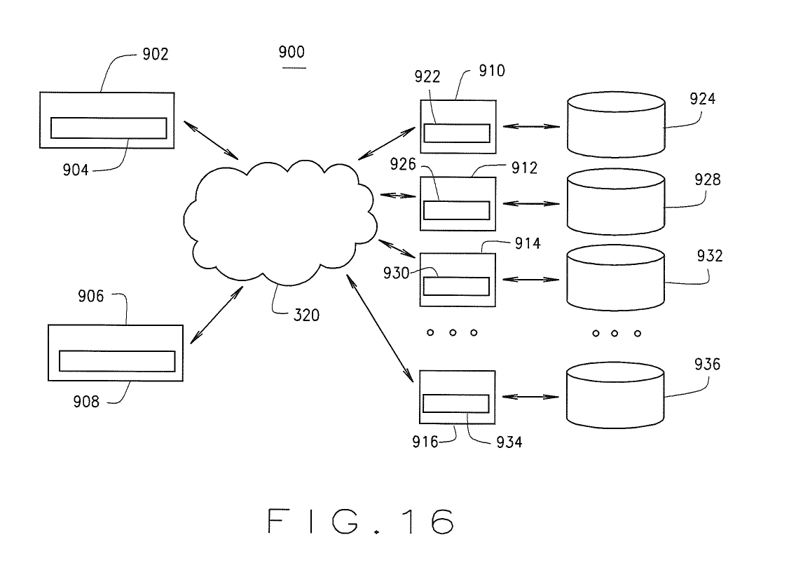

FIG. 16 illustrates a detailed exemplary client-server environment 900. Environment 900 of FIG. 16 includes the aforementioned communications network 320, a plurality of clients 902, 906 and a plurality of servers 910, 912, 914, 916 connected to network 320. The servers 910, 912, 914, 916 are shown connected to a plurality of database servers (DSs). Specifically, server 910 is connected to DS 924, server 912 is connected to DS 928, server 914 is connected to DS 932, and server 916 is connected to DS 936. As one example, the timing system 104 can be implemented as a server 914 and one or more biometric modules 122 can be implemented as a client, 902, 906.

The clients 902, 906 and the servers 910-916 are nodes connected to network 520, defined by their respective information retrieval functions. Client 902 includes a client application 904, which is an information requesting or receiving application associated with client 902, and client 906 includes a client application 908, which is an information requesting or receiving application associated with client 906. Client applications 904, 908 can run either on clients 902, 906, respectively, or can run on another node and are then passed to the clients 902, 906. In one or more embodiments, the client applications 904, 908 are web browsers.

Servers 910-916 include a variety of processes, including operating systems, web server applications and application servers. The operating systems, which can also be called platforms, are the software programs that applications use to communicate with the physical parts of the servers 910-916. Examples of operating systems that can be used with the present invention include: Linux™, Sun Solaris™, Windows NT/2000™, Cobalt RaQ™, and Free BSD™, although any operating systems known or anticipated can be used.

The web server applications are software running on servers 910-916 that make it possible for the client browsers 904, 908 to download stored web pages. These applications also coordinate streaming audio, video, and secure e-commerce, and can be integrated with databases (as described below) for information retrieval. Examples of web server applications that can be used with the present invention include: Apache™, Microsoft's Internet Information Server (IIS)™, O'Reilly & Associates WebSite Pro™, Netscape's FastTrack Server™, and StarNine's WebSTAR™ (for Macintosh), although any operating systems known or anticipated can be used.

The application servers sit on top of the formatting and display languages (for example, HTML) such that a request from clients 902, 906 is generated and translated as a request to the databases. Upon receiving information from databases, the application servers will translate this information back to the formatting and display languages and sent a response back to the browser. In one or more embodiments, the application server software resides at the servers 910-916, although with cross-platform programming technology, software performing the same functions can reside at clients 902, 906 as well. In one or more embodiments, the application servers will insert strings of programming code into the formatting and display language, with client browsers 904, 908 employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server™, Oracle Application Server™, PowerTier for C++™, PowerTier for Enterprise Java Beans™, Secant Extreme™, Enterprise Server™, SilverStream™, WebEnterprise™, WebSpeed™, and WebSphere™ although any application servers known or anticipated can be used.

Taken together, the web servers and applications servers perform at least these functions: (i) providing an environment upon which server components can run; (ii) functioning as is a main program under which other components run as subroutines; (iii) providing services (for example, security related services, transaction related services), state management, and resources (for example, database connections); (iv) enabling communication with clients 902, 906.

For the convenience of condensing terminology, the aforementioned applications working, which work together on the servers 910-916 (or instead are processed at other nodes and passed to servers 910-916) are referred to as “application servers.” FIG. 11 illustrates applications servers (ASs) 922, 926, 930, 934 respectively can run on clients 910, 912, 914, 916. In operation, client browsers 904, 908 are used to issue requests for information, or queued to transmit information, over network 520. Requests and responses are handled by servers 910-916 via running of ASs 922, 926, 930, 934, which in turn transmit information over network 520 for display by browsers 904, 908.

In one or more embodiments, additional functions required of ASs 922, 926, 930, 934 will be to connect the web servers 910-916 to, for example, back-end data resources such as relational tables, flat files, e-mail messages, and directory servers. In exemplary embodiments, additional programs incorporated in ASs 922, 926, 930, 934 typically called “middleware,” database utilities, or database management systems (DMBS) can be used, among other known or anticipated database methods.

For example, the ASs 922, 926, 930, 934 can include their own internal DBMSs, or DBMSs of other nodes, or the DBMSs labeled database servers (DSs) 924, 928, 932, 936. The DBMS refers to computer software for storing, maintaining, and searching for data in a database. In the present invention, the DBMS can also utilize facilities for increasing reliability and performance, and integrity, such as indexes, logging, and record locking.

In one or more embodiments, the DBMS includes interfaces for searching for and locating particular data items from the database and for presenting the result of these queries to a search engine. A search engine as used herein searches the database in response to a user request, which can be initiated at client browser 902, 906, for example, or at server 922-924, for example, and returns a result to the user, for example in the form of a relational table viewable in browsers 904, 908. The DBMS can refer to any type of database, including a relational DBMS (RDBMS), LDAP™, VSAM™, IMS™, Active Directory Services™, message stores, to name a few.

In one or more embodiments, the DBMS is an RDBMS that uses relational database to retrieve information from the timing system 104 to obtain participant data including biometric data 120. In one or more embodiments, the relational database uses structured query language (SQL™), including SQL defined according to International Standards Organization (ISO) and American National Standards Institute (ANSI) standards, or follow these standards with additional language constructs. In one or more exemplary embodiments, ASs 922-924 are respectively connected to DSs 924-936 via an application programming interface (API), including for example the open database connectivity (ODBC™), Java database connectivity (JDBC™), APIs.

Any types of DBMS platforms can be used in the various systems and components of the systems described herein and methods thereof. Exemplary platforms that can be employed include Sun Microsystems' Java™, 2 Platform, Enterprise Edition (J2EE)™ that contains an Enterprise JavaBeans™. (EJB) server-side component architecture, and Microsoft's Windows™, Distributed interNet Applications Architecture (Windows DNA™), which contains the COM+198 server-side component architecture.

As described, the presently disclosed system and method is an improved timing system that utilizes identifying of a location of the RFID tag within a coordinate system and utilizing the determined location for determining the time of passing of the participant past a monitored line that is within the same coordinate system. In this manner, the present system and method provides a more accurate determination of the actual point of passing of the participant past the monitored line than prior art RFID tag reader based timing systems.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1. A system for identifying a geographic location of an RFID tag with a unique tag identifier within a monitored area having a predefined X, Y, Z coordinate system, the system comprising:
a tag reader having a computer, a memory, an output interface and an input interface, the input interface being communicatively coupled to a first RFID antenna having a first antenna identifier and a second RFID antenna having a second antenna identifier with each positioned proximate to the monitored area and spaced apart from each other, the tag reader receiving a first RFID tag read with the tag identifier from the first RFID antenna and a second RFID tag read with the tag identifier from the second of the RFID antenna, the tag reader determining a first tag read time and a first tag read parameter associated with the received first tag read and determining a second tag read time and a second tag read parameter associated with the received second tag read, the tag reader transmitting a first tag read message including the tag identifier, the first tag read time, the determined first tag read parameter, and the first antenna identifier over the output interface and transmitting a second tag read message including the tag identifier, the second tag read time, the determined second tag read parameter and the second antenna identifier over the output interface; and
a RFID tag location system receiving the first tag read message and the second tag read message from the tag reader, comparing the determined first tag read parameter with the determined second tag read parameter as received in the first and second tag read messages, and determining a tag position of the RFID tag within the coordinate system of the monitored area as a function of the comparing.

2. The system of claim 1 wherein the RFID tag location system compares the first tag read time with the second tag read time as received in the first and second tag read messages, and the determining of the tag position of the RFID tag within the coordinate system of the monitored area is also a function of the comparing of the first and second tag read times.

3. The system of claim 1 wherein the monitored area includes a monitored line, and wherein the RFID tag location system determining a time of passing of the RFID tag past the monitored line responsive to the determined tag position and at least one of the first tag read time and the second tag read time.

4. The system of claim 1 wherein the determined first tag read parameter is a first RF signal strength of the first tag read and the determined second tag read parameter is a second RF signal strength of the received second tag read.

5. The system of claim 1 wherein the RFID tag location system includes a location determination module including computer executable instructions for triangulation for performing the comparing and determining.

6. The system of claim 1 wherein the determined first tag read parameter and the second tag read parameter are each selected from the group consisting of a signal strength of the received RF tag read, a relative radio frequency sign strength of the RF tag read, an RF polarization, a RF polarization shift, a phase of the received RF tag read, a phase shift of the received RF tag read, a propagation delay of the RF tag read, a Q value of the RFID tag, a signal strength of a tag read request or wakeup message sent from an antenna and as received by the RFID tag.

6. (canceled)

7. The system of claim 1 wherein the RFID tag location system includes a predefined first antenna position within the monitored coordinate system and a second predefined antenna position within the monitored coordinate system and wherein the determining of the tag position within the monitored area coordinate system is a function of the first and second predefined antenna positions.

8. The system of claim 7 wherein the RFID tag location system includes a first antenna pattern for the first antenna as defined within the monitored coordinate system and a second antenna pattern defined within the monitored coordinate system, and wherein determining is a function of comparing the first tag read parameter to the first antenna pattern and the second tag read parameter to the second antenna pattern.

9. The system of claim 8 wherein each of the first antenna pattern and the second antenna pattern are defined within the RFID tag location system by three dimensional antenna radiation patterns each defining a plurality of antenna radiation energy levels of the relative antenna within the monitored area coordinate system and wherein the first tag read parameter is a signal strength of the first tag read and the second tag read parameter is a signal strength of the second tag read and the determining includes an association of the first tag read parameter with the first antenna pattern and the second tag read parameter includes an association of the second tag read parameter with the second antenna pattern.

10. The system of claim 8 wherein the RFID tag location system stores each of the first and second tag read messages including the first and second tag read times and determines a duration of the RFID tag within each of the first antenna pattern of the first antenna and the second antenna pattern of the second antenna, wherein the RFID tag location system determines the tag position at least in part on a comparison of determined tag duration in at least one of the first and second antenna patterns.

11. The system of claim 9 wherein the antenna radiation pattern of the first antenna is calibrated during placement of the first antenna at the first antenna position and the antenna radiation pattern of the second antenna is calibrated during placement of the second antenna at the second antenna position and each antenna calibration is stored in a memory of the RFID tag location system and wherein the determining is a function of at least one of the stored antenna calibrations.

12-13. (canceled)

14. The system of claim 10 wherein the first and second antenna are calibrated and positioned so that the first antenna pattern and the second antenna pattern at least partially overlap and that all coordinate points within the coordinate system of the monitored area are within at least one of the first antenna pattern and the second antenna pattern.

15. The system of claim 10 wherein the first and second antenna are calibrated to transmit each read request and to receive the tag read from the RFID tag at a first frequency and a second frequency respectively, the first frequency being different from the second frequency and the first and second frequency varying over time.

16. The system of claim 1 wherein the tag reader provides a first tag read request to the first antenna and provides a second tag read request to the second antenna, and wherein the first antenna transmits a first tag read message to the RFID tag responsive to receiving the provided first tag read request and the received first tag read is responsive to the first tag read message, and wherein the second antenna transmits a second tag read message to the RFID tag responsive to receiving the provided second tag read request and the received second tag read is responsive to the second tag read message.

17. The system of claim 16 wherein the tag reader provides a first tag frequency with the first tag read request and a second frequency that is different from the first frequency with the second read request, and wherein the first antenna transmit the first tag read request and receives the tag read at the first frequency and the second antenna transmits the second tag read request and receives the second tag read at the second frequency.

18. The system of claim 1 wherein the tag reader determines a first antenna transmit parameter for the first antenna for transmitting the first tag read message and determines a second antenna transmit parameter for the second antenna for transmitting the second tag read message, wherein the first antenna transmits the first tag read message at the determined first antenna transmit parameter and the second antenna transmits the second tag read message at the determined second antenna transmit parameter, and wherein the tag reader transmits the determined first antenna transmit parameter with the first tag read message and transmits the determined second antenna transmit parameter with the second tag read message, and wherein the determining of the tag position within the coordinate system by the RFID tag location system is a function of the received first antenna transmit parameter and the received second antenna transmit parameter.

19. The system of claim 18 wherein the first antenna transmit parameter is a first antenna power level and the second transmit parameter is a second antenna power level and wherein the first tag read parameter is a signal strength of the first tag read and the second tag read parameter is a signal strength of the second tag read.

20. The system of claim 18 wherein the first antenna transmit parameter is a first antenna power level and the second transmit parameter is a second antenna power level and wherein the first tag read parameter is a signal strength of the first tag read and the second tag read parameter is a signal strength of the second tag read.

21. The system of claim 18 wherein the first antenna transmit parameter is a first antenna frequency and the second transmit parameter is a second antenna frequency.

22. The system of claim 1 wherein the tag reader adjusts a rate of tag reads for the first antenna based on a determined signal strength of the received first tag read.

23. The system of claim 1 wherein the tag reader ignores one or more first tag reads from the first antenna and prioritizes a reading of first tag reads as a function of the received second tag from the second antenna.

24. The system of claim 1 wherein the RFID tag is a first RFID tag within the monitored area, and wherein RFID tag location system differentiates the first RFID tag from a second RFID within the monitored area based on the determined position.

25. The system of claim 1 wherein the monitored area includes a monitored line defined within the monitored area coordinate system and such is stored in a memory of the RFID tag location system, the RFID tag location system further determining a relative Y distance position of the RFID tag from a comparison of the Y coordinate of the determined tag position within the coordinate system and the Y coordinate of the monitored line.

26. The system of claim 25 wherein the RFID tag location system determines a time of passing of the RFID tag past the monitored line when the determined relative Y distance position is about zero and as a function of the tag read time in the tag read message associated therewith, wherein the monitored line includes an X distance defining an X width of the monitored line across the monitored area, wherein the RFID tag location system determines the X position coordinate of the RFID tag relative to the X width of the monitored line and the monitored area has a surface with a Z distance defining the surface within the coordinate system, wherein the RFID tag location system determines a height of the RFID tag within the monitored area above the surface.

27-30. (canceled)

31. The system of claim 1 wherein the RFID tag reader receives a plurality of first and second tag reads, and for each determines a tag read time and a tag read parameter and transmits a tag read message containing each to the RFID tag location system, and wherein the RFID tag location system receives the plurality of tag read messages with the plurality of first and second tag reads, first and second tag read times and first and second tag read parameters, and wherein the RFID tag location system performs a plurality of comparing and determining processes to determine a plurality of tag positions of the RFID tag within the coordinate system, each determined tag position being different.

32. The system of claim 31 wherein the RFID tag location system further determines a velocity of the RFID tag within the coordinate system as a function of the plurality of determined tag positions.

33. The system of claim 1 wherein the RFID tag is a first RFID tag within the monitored area, and wherein RFID tag location system differentiates the first RFID tag from a second RFID tag within the monitored area based on the determined position of the first RFID tag as compared to a determined position of the second RFID tag.

34. The system of claim 1 wherein the first antenna receives the first tag read at a first frequency and the second antenna receives the second antenna at a second frequency.

35. The system of claim 1 wherein the RFID tag location system includes an output interface, the output interface transmitting a remote action control message to a communicatively coupled system responsive to the determined tag position for initiating an action by the remote system responsive to transmitted remote action control message.

36-79. (canceled)

80. The system of claim 1 wherein the determined RFID tag position is a coordinate position defined by an x, y, z value.
